(19) United States
(12) Patent Application Publication
(10) Pub. No.: US 2012/0267061 A1
(43) Pub. Date: Oct. 25, 2012

(54) Shading Apparatus For Portable Device Holder

(76) Inventor: Eagle Fan, Hsinchu (TW)

(21) Appl. No.: 13/093,823

(22) Filed: Apr. 25, 2011

(51) Int. Cl. E06B 9/24

(52) U.S. Cl. 160/368.1

(57) ABSTRACT

A shading apparatus is provided, applicable to a holding base of a portable device holder, including a shading plate and an elastic band. The shading plate is a plate with a rectangular shape. The two ends of the elastic band are slightly pulled and fixed to the shading plate at the location near the edges on two sides. In this manner, the shading plate can be fixed to the clamping element of the holding base by winding the elastic band around the clamping element so that the shading plate can effectively block the sun from directly shining on the screen of the portable device when the portable device is held by the clamping elements and placed in the horizontal position.

### FIELD OF THE INVENTION

The present invention generally relates to a shading apparatus for portable device holder, and more specifically to a shading apparatus applicable to the portable device holder used in vehicle to shade the held electronic device.

### BACKGROUND OF THE INVENTION

Global Positioning System (GPS) is a convenient navigation system found in many vehicles nowadays. As more and more high-end mobile phone or PDA also includes the built-in GPS functions, many mobile phones or PDA are often placed above the dash board to act as a GPS during driving. In addition, the popularity of mobile phone for communication as well as other audiovisual playing functions has made portable electronic devices, such as mobile phones, an indispensable part of the entire driving duration. However, because some applications on the mobile phone must be operated in the portrait mode, while other applications need to be operated in landscape mode, device holder is often employed to hold the mobile phone in the vehicle during driving to provide the user the hand-free usage. The device holder usually consists of a holding base and a related suction disc set so that the holder, along with the portable device, is firmly fixed to the surface above the dash board. Of course, the holding base and the related suction disc set must be adjustable to allow angle adjustment for best viewing of the display of the portable device.

Unfortunately, if the ambient lighting condition is not ideal, for example, strong direct sunlight, or the angle adjustment is poor, the user often fails to see the information displayed on the portable device clearly. Therefore, how to solve the above viewing problem and providing the user the optimal viewing experience becomes an important issue for using the device holder in the vehicle.

### SUMMARY OF THE INVENTION

The primary object of the present invention is to provide a simple shading apparatus for portable device holder used in vehicle, mainly applicable to a holding base of a portable device holder. The holding base of a common device holder usually includes two clamping elements facing each other so that the portable device is held between the clamping elements. When the placement of the portable device is changed from vertical to horizontal, the clamping has also changed from clamping on two sides to clamping on top and bottom edges of the portable device. In this manner, the shading apparatus of the present invention can be temporarily fixed to the clamping element on the top edge of the portable device. With a large-area shading plate to block the sunray directly shining on the display of the portable device, the user can view the information displayed on the screen of the portable device easily and with more clarity.

Another object of the present invention is to provide a shading apparatus with simple structure, convenience of use and economical unit price suitable for use with portable device holder used in the vehicle.

To achieve the above objects, the present invention provides a shading apparatus for portable device holder, including a shading plate and an elastic band. The shading plate is a plate with a rectangular shape. The two ends of the elastic band are slightly pulled and fixed to the shading plate at the location near the edges on two sides. In this manner, the shading plate can be fixed to the clamping element of the holding base by winding the elastic band around the clamping element so that the shading plate can effectively block the sun from directly shining on the screen of the portable device when the portable device is held by the clamping elements.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a shading apparatus for portable device holder according to the invention;

FIG. 2 shows a schematic view from a different angle according to the present invention;

FIG. 3 shows a schematic view of the present invention applied to a holding base according to the present invention; and

FIG. 4 shows a schematic view of the present invention in actual application.

### DETAILED DESCRIPTION OF THE PREFERRED EMBODIMENTS

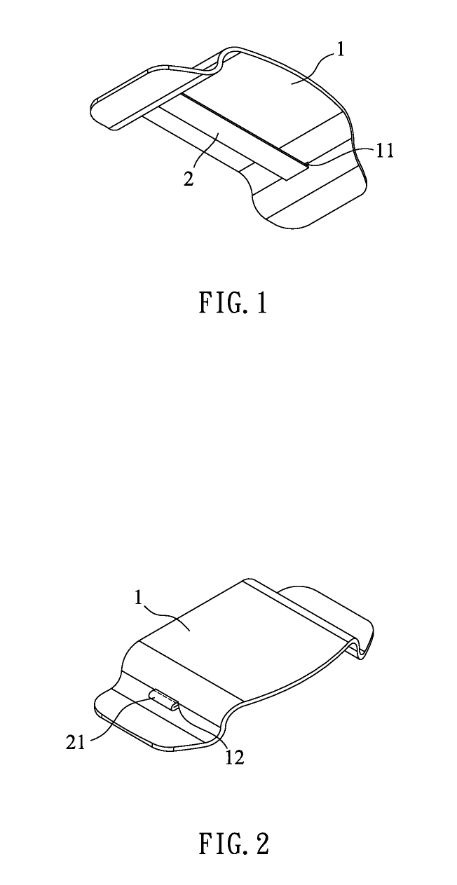

FIG. 1 and FIG. 2 show the schematic views of the present invention. The shading apparatus for portable device holder includes a shading plate 1 and an elastic band 2. Shading plate 1 is a plate with rectangular shape and large area. The central part of the plate is slightly uplifted. The shape is to match the shape of the clamping element of the holding base. The junction of the uplifted area the flat area of shading plate 1 forms holes 11, 12 for elastic band 2 to pass through. Holes 11, 12 are located close to the two narrower sides of shading plate 1. In the present embodiment, elastic band 2 is a wide elastic band, but is not limited to the above embodiment. A plurality of narrow elastic band can also be used as elastic band 2. Elastic band 2 is slightly pulled (to slightly tight so that the fixing force is sufficiently strong) with two ends fixed to shading plate 1, in the direction parallel to the wider sides of shading plate 1. Elastic band 2 can be fixed to shading plate 1 in a plurality of manners, for example, by gluing elastic band 2 to shading plate 1. In the present embodiment, the two ends of elastic band 2 pass through holes 11, 12 respectively to the other surface of shading plate 1, and sewing a segment of the band into a larger stopping block 21 or directly fixed to a block so that elastic band 2 cannot be disengaged from shading plate 1. Also, the location of elastic band 2 is preferably close to a wider side of shading plate 1.

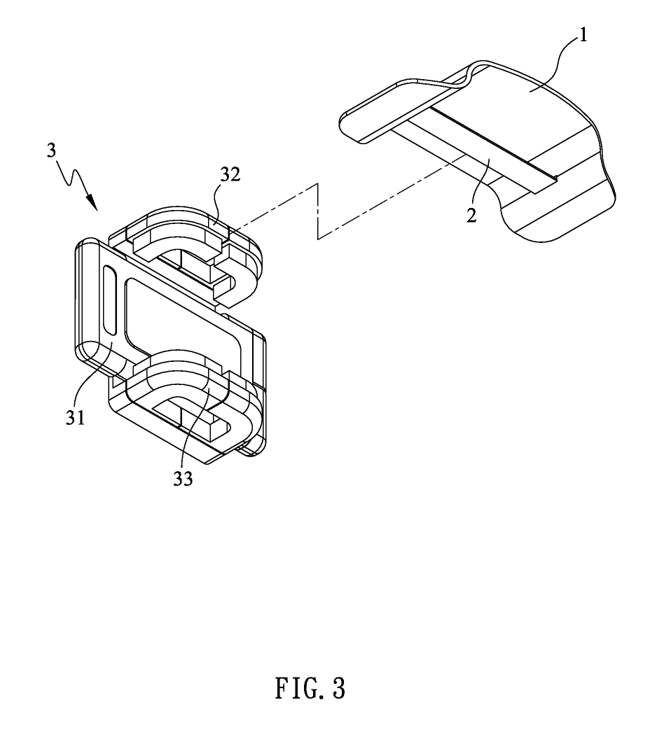

FIG. 3 shows a three-dimensional schematic view of applying shading apparatus to a holding base according to the present invention. Holding base 3 is a generic type, and not limited to any specific structure. Holding base 3 mainly includes a base 31 and clamping elements 32, 33 located on two facing sides of base 31. Holding base 31 can be placed vertically or horizontally. When holding base 3 is placed vertically, clamping elements 32, 33 clamp the right and left sides of the held portable device. When holding base 3 is placed horizontally, clamping elements 32, 33 clamp the top and bottom sides of the held portable device. In FIG. 3, holding base 3 is placed horizontally. The shading plate of the present invention uses elastic band 2 to wind around the inner edge of clamping element 32 of holding base 3, and shading plate 1 is lying against the outer wall of clamping element 32 so that shading plate 1 covers the area above clamping element 32 to achieve the object of shading. In addition, because elastic band 2 is made of soft material, elastic band 2 will not interfere with the friction or clamping effect between clamping element 32 and held portable device.

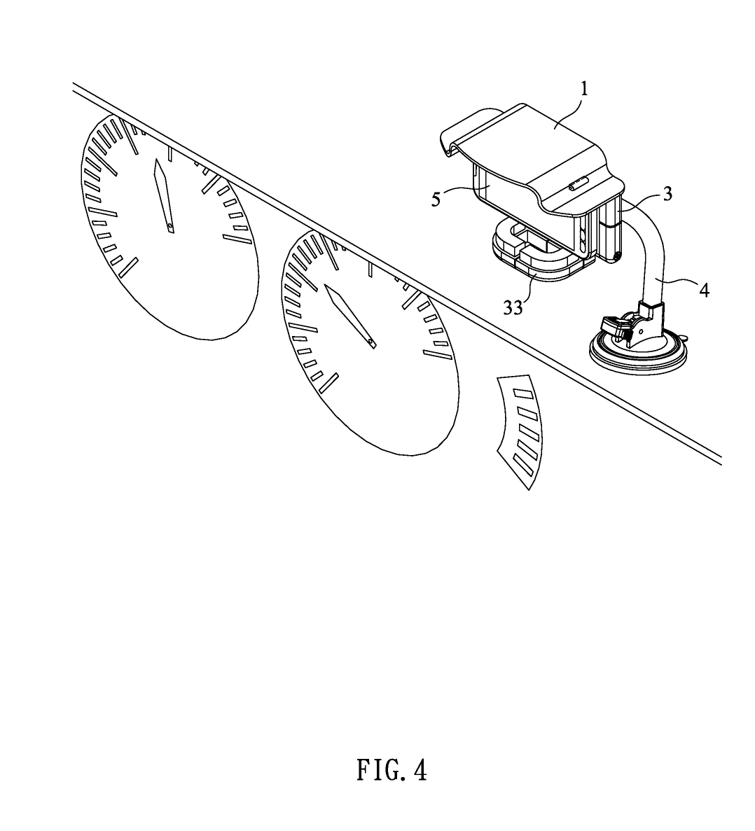

FIG. 4 shows a schematic view of the present invention in actual application. Holding base 3 is used in combination with a suction disc set 4, and uses suction disc set 4 to attach to the flat surface above the dash board. An portable device 5 is held by holding base 3. The portable device can be a mobile phone. As when the mobile phone is placed horizontally for applications, the driver usually needs to view the contents displayed on the screen of the mobile phone, such as, switching to GPS mode, or media playing mode. When the mobile phone is placed horizontally for applications, clamping elements 32, 33 clamp the top and bottom edges of the mobile phone so that shading plate 1 can be attached to clamping element 32 by elastic band 2 to shield the portable device from direct sunshine to enable optimal viewing of the screen.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A shading apparatus for portable device holder, comprising: a shading plate and at least an elastic band, said shading plate being a large-area plate, said elastic band being slightly tight with two ends fixed to said shading plate, in this manner, said shading plate being applicable to a holding base, said holding base capable of holding a portable device.

2. The shading apparatus as claimed in claim 1, wherein central area of said shading plate is slightly uplifted.

3. The shading as claimed in claim 1, wherein said elastic band is positioned on said shading plate in a direction parallel to wider side of said shading plate.
